(19) United States
(12) Patent Application Publication
(10) Pub. No.: US 2003/0163580 A1
(43) Pub. Date: Aug. 28, 2003

(54) Data transmission protocol using short message service

(75) Inventor: Sang-Seo Lee, Seoul (KR)

Correspondence Address: SUGHRUE MION, PLLC, 2100 Pennsylvania Avenue, NW, Washington, DC, 20037-3213, US

(73) Assignee: SAMSUNG ELECTRONICS CO., LTD.

(21) Appl. No.: 10/394,678

(22) Filed: Mar. 24, 2003

Related U.S. Application Data
(62) Division of application No. 09/503,506, filed on Feb. 14, 2000.

(30) Foreign Application Priority Data
Feb. 13, 1999 (KR) 99-5238

(51) Int. Cl. G06F 15/16

(52) U.S. Cl. 709/230

(57) ABSTRACT

A data transmission protocol and apparatus using a short message service is provided. The data transmission protocol includes the steps of inserting a data connection service identifier into a user data field. Input message data is segmented into a plurality of short message data fields, and a segmented message data field, a field indicating the number of segmented short messages and a field indicating a current short message number, are inserted into the user data field. A short message field is generated using the user data field. The short message field is transmitted, thereby transmitting relatively large volume of data such as a simple picture and a rough sketch while using the short message service.

### BACKGROUND OF THE INVENTION

1. Field of the Invention

The present invention relates to a data transmission protocol and an apparatus performing transmission according to the data transmission protocol, and more particularly, to a data transmission protocol and apparatus using a short message service.

2. Description of the Related Art

FIG. 1 shows the format of a short message frame which is used in a conventional short message transmission protocol. FIG. 2 is a diagram for explaining the procedure of message transmission according to the protocol. FIGS. 3A through 3C are diagrams illustrating examples of the procedure of transmitting a short message according to a conventional short message protocol. FIG. 3A shows the procedure of short message transmission when a collection message does not have a response option. FIG. 3B shows the procedure of short message transmission when a collection message has a delivery response option. FIG. 3C shows the procedure of short message transmission when a collection message does not have a delivery response option.

According to a conventional short message transmission protocol, a user creates a message of an appropriate length using an originating terminal and inputs a send command instructing the originating terminal to transmit the message. The originating terminal then attempts short message transmission by sending a field 10 in the form of a short message as shown in FIG. 1 to a base station in response to the send command. Short messages from a plurality of sending terminals are collected and delivered to a short message center by the base station. Accordingly, a short message which is sent from an originating terminal is referred to as a collection message. The short message center checks a destination terminal address of the received collection message and transmits the short message in the form of a delivery message to a destination terminal corresponding to the address. The collection message may not have a delivery response request option as shown in FIG. 3A. In this case, when the collection message from an originating terminal is converted into a delivery message format in a short message center and transmitted to a destination terminal, response to the delivery is not requested. As shown in FIG. 3B, a collection message may have a delivery response request option. In this case, an originating terminal adds the delivery response request option to the field format of the collection message before transmission to a short message center. The short message center separately transmits a transport message along with a delivery message when it is determined that the collection message has a delivery response request option. A destination terminal then receives the delivery message and sends the transport message, which has been transmitted from the short message center, back to the short message center. When the transport message from the destination terminal arrives at the short message center, the short message center sends a delivery response message to the originating terminal.

FIG. 3C shows another case in which a collection message does not have a delivery response request option. In this case, the collection message from an originating terminal is converted into a delivery message format in a short message center and then transmitted to a destination terminal. Once the destination terminal receives the delivery message, it sends a user response message to the short message center. When the user response message arrives, the short message center sends the user response message to the originating terminal.

Sometimes, a short message cannot be transmitted to a destination terminal when the destination terminal cannot perform reception, when the short message center is overloaded, or when the air wave environment is poor. To measure the above problem, retransmission is periodically performed or performed when necessary according to a transmission state. Time intervals of retransmissions or the number of retransmissions may be different depending on a parameter of a received short message.

However, according to the conventional short message transmission protocol, the length of a short message is limited to a predetermined length when transmitting or receiving a message. Consequently, data service is very limited. Recently, large-sized screens of liquid crystal display units have been developed, but the conventional short message transmission protocol cannot efficiently utilize the developed devices. To solve these problems, a new data transmission protocol may be applied, but this creates a problem in changing message service centers.

### SUMMARY OF THE INVENTION

To solve the above problems, it is an objective of the present invention to provide a data sending protocol for segmenting message data into a plurality of short messages when sending the message data, so as to allow message data, which is longer than a conventional transmittable message data, to be transmitted while still using a conventional short message service.

It is another objective of the present invention to provide a data reception protocol for receiving segmented short messages in response to the above data sending protocol.

It is yet another objective of the present invention to provide a data sending apparatus for performing an expanded data service using the data sending protocol.

It is still yet another objective of the present invention to provide a data receiving apparatus for performing an expanded data service using the data reception protocol.

Accordingly, to achieve the above objective, there is provided the data transmission protocol including the steps of (a) inserting a data connection service identifier into a user data field; (b) segmenting input message data into a plurality of short message data fields and inserting a segmented message data field, a field indicating the number of segmented short messages and a field indicating a current short message number, into the user data field; (c) generating a short message field using the user data field; and (d) transmitting the short message field.

Preferably, the step (a) uses a code, which is not used in a KS5601 standard or an ASCII code table, for the data connection service identifier, and the code is 98H or 99H.

Preferably, the data sending protocol also includes a step of (e) inserting a reference number field, which indicates a number for referring to the type of data connection service, into a position next to the data connection service identifier in the user data field.

Preferably, the data sending protocol additionally includes a step of (f) translating a delivery message and extracting an identifier requesting retransmission of data.

Preferably, the step (f) includes the steps of (f-1) extracting a field indicating the total number of short message and a field indicating a retransmission request short message number; (f-2) inserting, among the whole segmented short messages, a short message data field corresponding to the retransmission request short message number, into a user data field; and (f-3) generating a short message field using the user data field and retransmitting the short message field.

To achieve another objective, there is provided a data receiving protocol using short message service. The data receiving protocol includes the steps of (a) checking a user data field of a delivery short message to extract a data connection service identifier; if the data connection service identifier satisfies a predetermined condition, (b-1) translating data in a short message area among the user data field of the delivery message; and (b-2) storing and connecting a plurality of translated data; or if the data connection service identifier does not satisfy a predetermined condition, (c) performing an ordinary short message process.

Preferably, the step (b-1) includes a step of (b-1-1) extracting a field indicating the total number of short message and a field indicating a current short message number, and the step (b-2) comprises a step of (b-2-2) outputting the connected data to a higher processing layer after storing and connecting as many data fields as the total number of short message.

Preferably, if extraction of the data in the short message area fails in the step (b-1), the data receiving protocol also includes the steps of inserting a short message number of a field, in which extraction of the data fails, into a user data field as a retransmission request short message number; generating a short message field using the user data field; and transmitting the short message field.

Preferably, the step (a) extracts a code, which is not used in a KS5601 standard or an ASCII code table, as the data connection service identifier, and the code is 98H or 99H.

To achieve yet another objective, there is provided a data sending apparatus using a short message service. The data sending apparatus includes a data connection service identifier inserting unit for inserting a data connection service identifier into a user data field; a short message processing unit for segmenting input message data into a plurality of short message data fields and inserting a segmented message data field, a field indicating the number of segmented short messages and a field indicating a current short message number, into the user data field; a short message field generating unit for generating a short message field using the user data field; and a transmitting unit for transmitting the short message field.

To achieve still yet another objective, there is provided a data receiving apparatus using a short message service. The data receiving apparatus includes a service identifying unit for checking a user data field of a delivery short message to extract a data connection service identifier, outputting a control signal having a first logic level if the data connection service identifier satisfies a predetermined condition, and, if not, outputting a control signal having a second logic level; a short message field translating unit for translating data in a short message area among the user data field of the delivery message, in response to the control signal having the first logic level; a short message storage/connection unit for storing and connecting a plurality of translated data; and an ordinary short message processing unit for performing an ordinary short message process in response to the control signal having the second logic level.

### BRIEF DESCRIPTION OF THE DRAWINGS

The above objectives and advantages of the present invention will become more apparent by describing in detail a preferred embodiment thereof with reference to the attached drawings in which:

FIG. 1 is a diagram for showing the format of a short message frame which is used in a conventional short message transmission protocol;

FIG. 2 is a diagram for explaining the procedure of message transmission according to a conventional short message transmission protocol;

FIGS. 3A through 3C are diagrams for explaining examples of the procedure of transmitting a short message according to a conventional short message protocol;

FIG. 4 is a block diagram of a data sending apparatus using a short message service according to an embodiment of the present invention;

FIG. 5 is a block diagram of a data receiving apparatus using short message service according to an embodiment of the present invention;

FIG. 6 is a diagram for showing a data field format for application of a data transmitting protocol using short message service according to an embodiment of the present invention;

FIG. 7A is a diagram for explaining an example of message transmission procedure performed by a short message transmission protocol using the short message service according to the present invention; and

FIG. 7B is a diagram for explaining an example of message transmission procedure performed by a data transmission protocol according to the present invention.

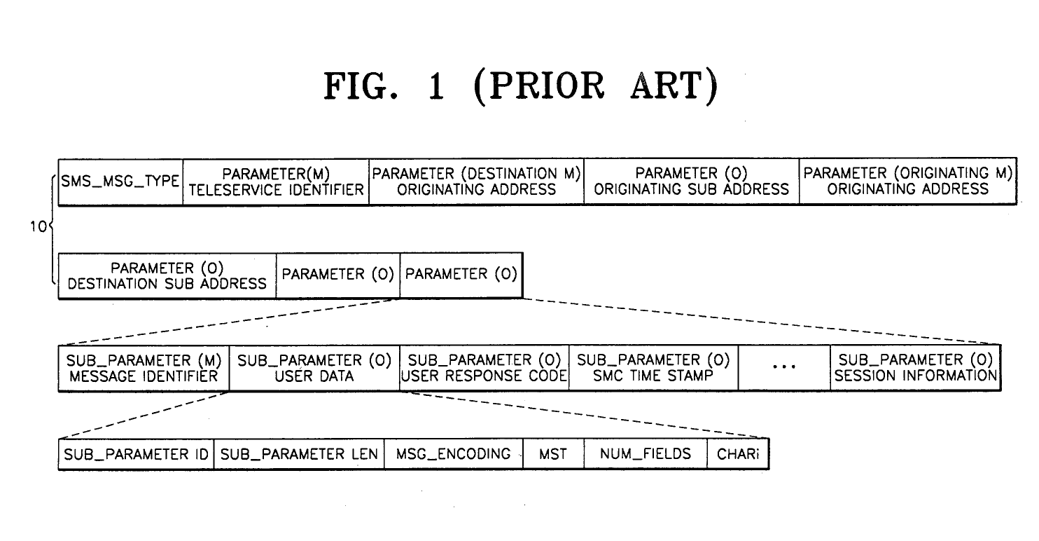

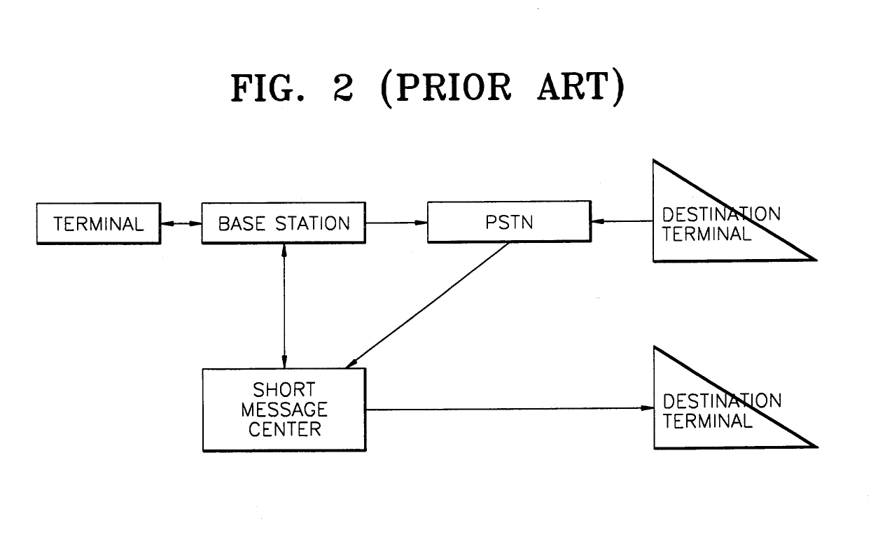

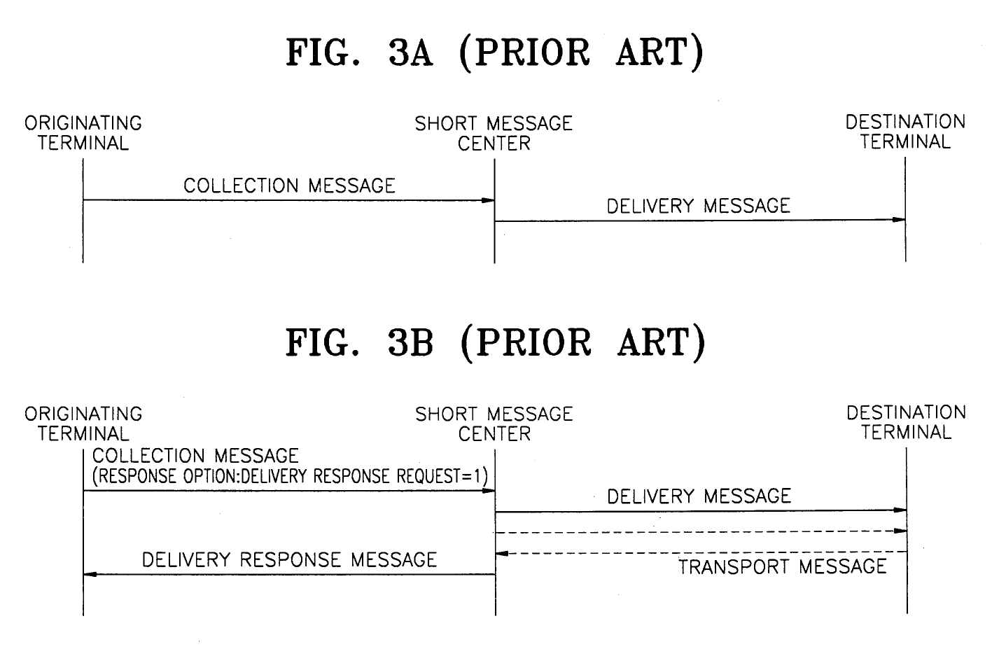

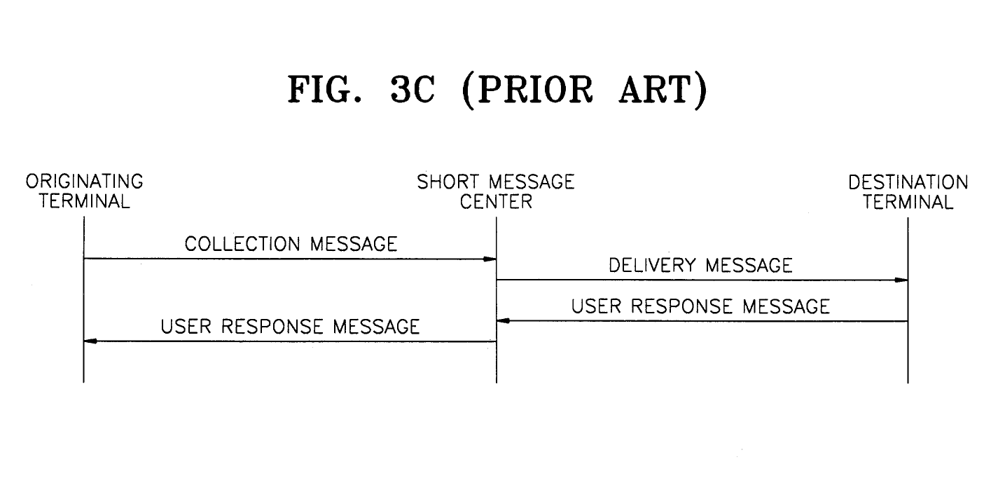

### DETAILED DESCRIPTION OF THE INVENTION

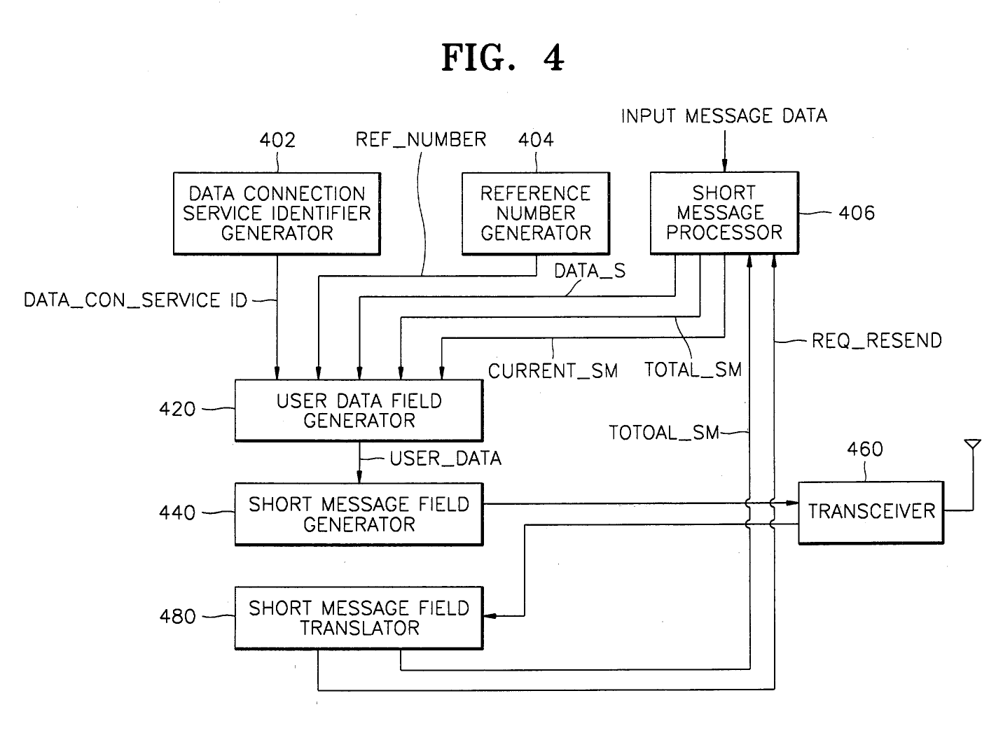

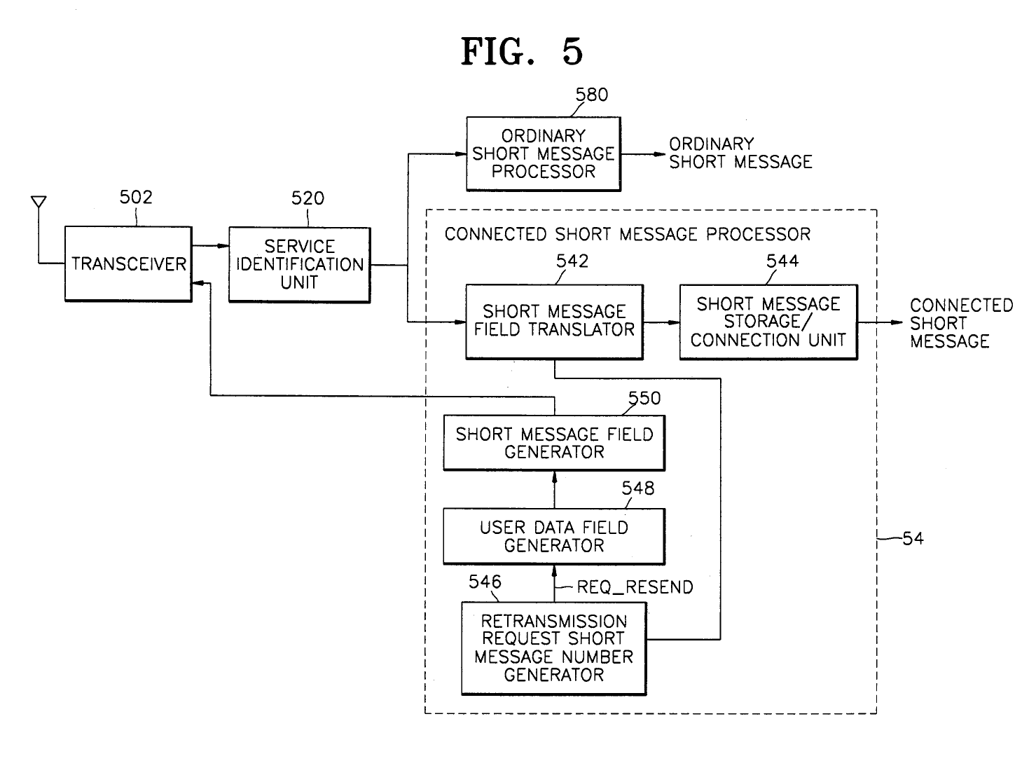

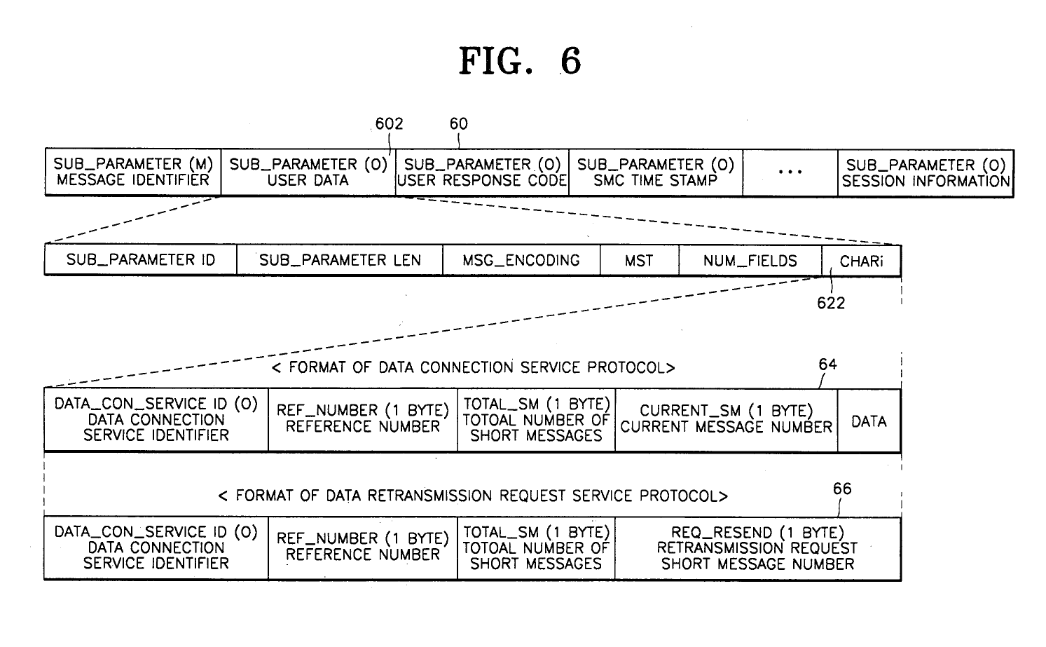

The present invention will now be described more fully with reference to the accompanying drawings, in which preferred embodiments of the invention are shown. FIGS. 4 and 5 show a data sending apparatus and a data receiving apparatus according to embodiments of the present invention, respectively. FIG. 6 shows a data field format for implementation of a data transmission protocol which is operated in the data sending and receiving apparatuses according to the present invention and is referred to as necessary hereinafter.

Referring to FIG. 4, the data sending apparatus according to the present invention includes a data connection service identifier generator 402, a reference number generator 404, a short message processor 406, a user data field generator 420, a short message field generator 440, a transceiver 460 and a short message field translator 480.

In the operation of the data sending apparatus, primarily, the data connection service identifier generator 402 generates a code, which is not used in the KS5601 standard or an ASCII code table, such as 98H or 99H as a data connection service identifier DATA_CON_SERVICE ID (0). The reference number generator 404 generates a 1 byte of reference number field REF_NUMBER, which represents a number for referring to the type of data connection service. The short message processor 406 segments input message data into a plurality of message data fields and outputs segmented message data fields DATA_S, a field TOTAL_SM indicating the number of segmented messages and a field CURRENT_SM indicating a current message data number. The user data filed generator 420 inserts DATA_CON_SERVICE ID (0), REF_NUMBER, DATA_S, a field TOTAL_SM into the user data field 602, and outputs the user data field 602. The short message field generator 440 generates a short message field 60 based on the user data field 602. The transceiver 460 10 transmits the short message field 60 over a channel.

When a short message transmitted over a channel does not normally arrive at a destination terminal because the air wave state is poor (i.e. interference) or the short message center is overloaded, a destination terminal (not shown) can send a delivery message requesting retransmission. The transceiver 460 receives the delivery message sent from the destination terminal.

The short message field translator 480 translates the delivery message output from the transceiver 460 and extracts an identifier indicating the request for data retransmission. If the retransmission request identifier is extracted, the short message field translator 480 extracts a field TOTAL_SM indicating the number of entire short messages and a field REQ_RESEND indicating the number of a short message which is requested to be retransmitted.

The short message processor 406 receives the field TOTAL_SM indicating the number of entire message data fields and the field REQ_RESEND indicating the number of retransmission request message data field, from the short message field translator 480, and outputs a message data field DATA_S corresponding to the retransmission request short message number. The short message processor 406 includes a short message storage unit (now shown) for storing a plurality of message data fields DATA_S which are obtained by segmenting input message data.

The user data field generator 420 generates a user data field by using the segmented message data fields DATA_S received from the short message processor 406. The short message field generator 440 generates a data field in the form of a short message using the user data field. Finally, the transceiver retransmits the short message field which has been requested to be retransmitted.

FIG. 5 is a block diagram of a data receiving apparatus according to another embodiment of the present invention. Referring to FIG. 5, the data receiving apparatus includes a transceiver 502, a service identification unit 520, a connected short message processor 54 and an ordinary short message processor 580. The connected short message processor 54 includes a short message field translator 542, a short message storage/connection unit 544, a retransmission request short message number generator 546, a user data field generator 548 and a short message field generator 550.

In the operation of the receiving apparatus, the service identification unit 520 checks the user data field 602 of a delivery short message field 60 and extracts a data connection service identifier DATA_CON_SERVICE ID(0). The service identification unit 520 then generates a logic high control signal if the extracted data connection service identifier DATA_CON_SERVICE ID(0) is 98H or 99H and, if not, generates a logic low control signal. The data connection service identifier DATA_CON_SERVICE ID (0) can be expressed using a code, which is not used in the KS5601 standard or the ASCII code table, other than 98H or 99H.

The short message field translator 542 translates data CHARi corresponding to a short message area in the user data field 602 and extracts a field TOTAL_SM indicating the number of entire short messages and a field CURRENT_SM indicating a current short message number, in response to the logic high control signal. If the short message field translator 542 fails in extracting the data CHARi, it outputs a field indicating the number of a message data field which failed to be extracted.

After storing translated data fields corresponding to the number of entire short messages, the short message storage/connection unit 544 connects the data fields and outputs connected data to a higher processing layer.

The retransmission request short message number generator 546 receives the field indicating the number of message data field which failed to be extracted from the short message field translator 542, and outputs a retransmission request short message number field REQ_RESEND indicating the number of s message data field which needs to be retransmitted. The user data field generator 548 receives the retransmission request short message number field REQ_RESEND and generates a user data field including the retransmission request short message number field REQ_RESEND. The short message field generator 550 generates a short message field using the user data field. The transceiver 502 transmits the short message field as a retransmission request delivery message over a channel.

On the other hand, the data connection service identifier DATA_CON_SERVICE ID (0) is not 98H nor 99H, the ordinary short message processor 580 performs ordinary short message processing in response to a logic low control signal.

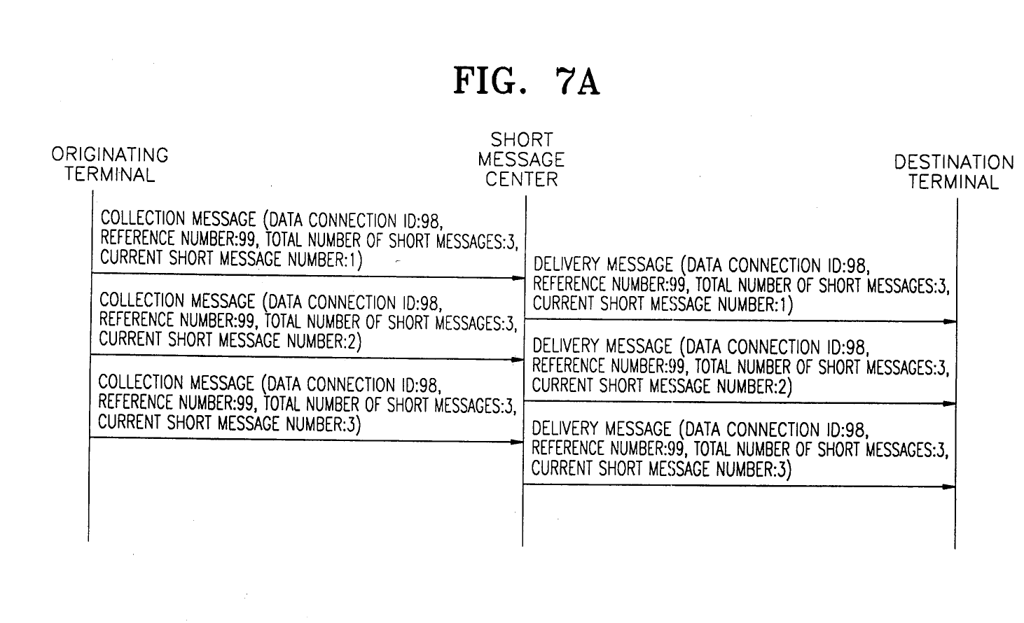

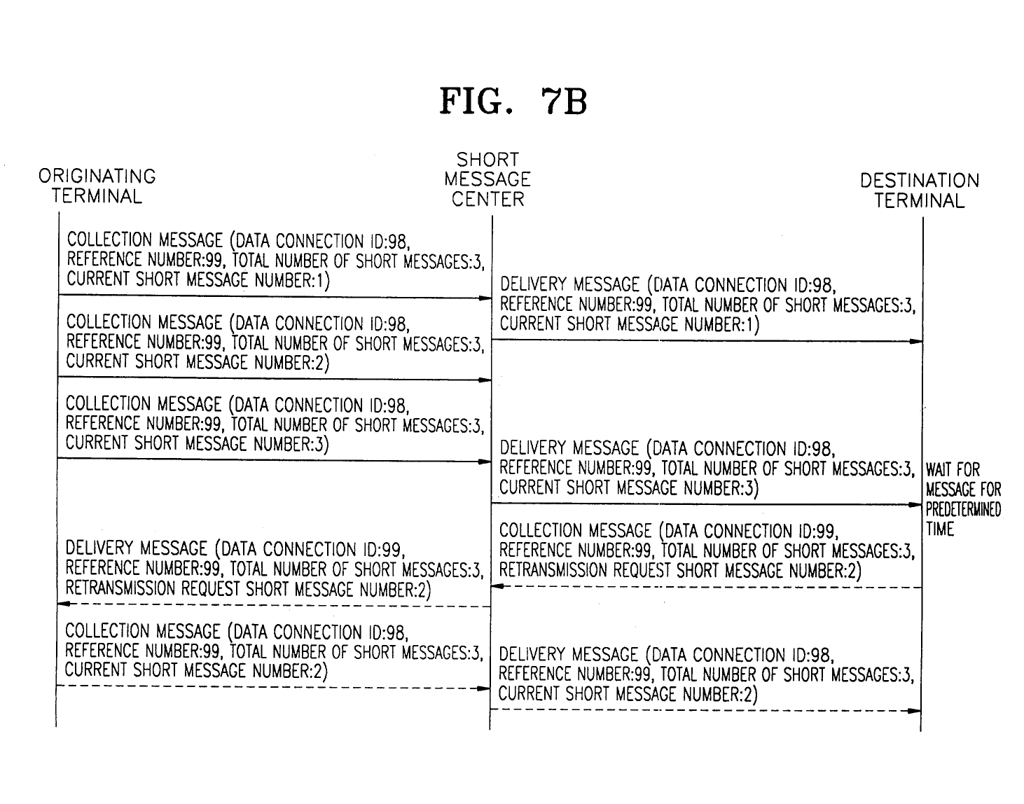

FIGS. 7A and 7B show examples of message transmission procedure according to a short message transmission protocol using short message service according to the present invention. In these examples, a message composed of three pieces of short message data is transmitted over a channel.

An originating terminal inserts 98H into a data connection identifier (ID) field, 99H into a reference number field, 3 into a total number of short messages field and 1 into a current short message number field to make a collection message and sends the collection message. A short message center does not check a new data protocol format of user data but transmits the short message as it is to a destination terminal. The destination terminal receives the short message and checks the short message to determine whether a first byte of a user data field, namely, a data connection service ID, is 98H or 99H. If it is determined that the data connection service ID is 98H or 99H, the destination terminal extracts a field indicating the total number of short message and a field indicating a current short message number for the operation of the data connection service, and receives all of the short messages corresponding to the number of short messages. As shown in FIG. 7A, the originating terminal sequentially sends collection messages respectively including user data fields in which the current short message number fields are set to 1, 2 and 3, respectively. The destination terminal sequentially receives the collection messages from the short message center. The destination terminal stands by for a predetermined time after checking the data connection service ID to receive as many short messages as the number which is extracted from the field indicating the total number of short messages.

However, the destination terminal may not receive a collection message sent from the originating terminal. In this occasion, the destination terminal inserts the number of the short message which is not received into a user data field, generates a short message field using the data field, and sends the short message field as a collection message to the short message center.

The originating terminal receives the retransmission request through the short message center. Then, the originating terminal retransmits the short message, which was not received by the destination terminal, in the form of a short message field. If the short message which was requested to be retransmitted is not received by the destination terminal within a predetermined time, the destination terminal discards the short messages which has been received before and is restored to an idle mode.

Consequently, a data transmission protocol according to the present invention allows transmission of data, such as a simple picture or a rough sketch, the volume of which cannot be transmitted by a conventional short service, while using a short message center. Therefore, various data can be transmitted using the short message service when employing the data transmission protocol of the present invention. In addition, the short message center does not need to be changed.

The data transmission protocol and apparatus of the present invention as described above can be made into programs which can be executed in a computer and this will be understood by those skilled in the art. The programs can be read from a computer-readable medium and executed by a common digital computer system. The computer-readable medium covers a storage medium such as a magnetic storage medium, e.g., ROM, a floppy disk or a hard disk, an optical readable medium, e.g., CD-ROM or DVD, or carrier wave, e.g., transmission through the Internet. Functional programs, code and code segments for the implementation of the present invention can be easily anticipated by programmers in the art of the present invention.

While this invention has been described in connection with what is presently considered to be the most practical and preferred embodiment, it is to be understood that the invention is not limited to the disclosed embodiment, but, on the contrary, it is intended to cover various modifications within the spirit and scope of the appended claims.

What is claimed is:

1. A data sending protocol using a short message service, the data transmission protocol comprising the steps of:
(a) inserting a data connection service identifier into a user data field;
(b) segmenting input message data into a plurality of short message data fields and inserting a segmented message data field, a field indicating the number of segmented short messages and a field indicating a current short message number, into the user data field;
(c) generating a short message field using the user data field; and
(d) transmitting the short message field.

2. The data sending protocol of claim 1, wherein the step (a) uses a code for the data connection service identifier which is not used in an ASCII code table.

3. The data sending protocol of claim 1, wherein the step (a) uses a code for the data connection service identifier which is not used in a KS5601 standard.

4. The data sending protocol of claim 2 or 3, wherein the code is 98H or 99H.

5. The data sending protocol of claim 1, further comprising a step of (e) inserting a reference number field, which indicates a number for referring to a type of data connection service employed, into a position next to the data connection service identifier in the user data field.

6. The data sending protocol of claim 1, further comprising a step of (f) translating a delivery message and extracting an identifier requesting retransmission of data.

7. The data sending protocol of claim 6, wherein the step (f) comprises a step of (f-1) extracting a field indicating a total number of short messages and a field indicating a retransmission request short message number.

8. The data sending protocol of claim 7, wherein the step (f) further comprises the steps of:
(f-2) inserting, among the segmented short messages, a short message data field corresponding to the retransmission request short message number, into a user data field; and
(f-3) generating a short message field using the user data field and retransmitting the short message field.

9. A data receiving protocol using short message service, the data receiving protocol comprising the steps of:
(a) checking a user data field of a delivery short message to extract a data connection service identifier;
when the data connection service identifier satisfies a predetermined condition,
(b-1) translating data in a short message area among the user data field of the delivery message; and
(b-2) storing and connecting said translated data; and
when the data connection service identifier does not satisfy said predetermined condition,
(c) performing an ordinary short message process.

10. The data receiving protocol of claim 9, wherein the step (b-1) comprises a step of (b-1-1) extracting a field indicating the total number of short messages and a field indicating a current short message number, and the step (b-2) comprises a step of (b-2-2) outputting connected data to a higher processing layer after storing and connecting as many data fields as the total number of short messages.

11. The data receiving protocol of claim 9, further comprising:
when extraction of data in the short message area in the step (b-1) fails, (b-1-2) inserting a short message number of a field, in which extraction of the data fails, into a separate user data field as a retransmission request short message number;
(b-1-3) generating a short message field using the separate user data field; and
(b-1-4) transmitting the short message field.

12. The data receiving protocol of claim 11, wherein the step (b-1-2) expresses short message numbers of fields whose data extraction fails, as retransmission request short message numbers, and inserts the retransmission request short message numbers into the separate user data field one at a time.

13. The data receiving protocol of claim 10, wherein the step (a) extracts a code as the data connection service identifier which is not used in an ASCII code table.

14. The data receiving protocol of claim 10, wherein the step (a) extracts a code as the data connection service identifier which is not used in a KS5601 standard.

15. The data receiving protocol of claim 13 or 14, wherein the code is 98H or 99H.

16. A data sending apparatus using a short message service, the apparatus comprising:
data connection service identifier inserting means for inserting a data connection service identifier into a user data field;
short message processing means for segmenting input message data into a plurality of short message data fields and inserting a segmented message data field, a field indicating the number of segmented short messages and a field indicating a current short message number, into the user data field;
short message field generating means for generating a short message field using the user data field; and
transmitting means for transmitting the short message field.

17. The data sending apparatus of claim 16, wherein the data connection service identifier inserting means uses a code for the data connection service identifier which is not used in an ASCII code table.

18. The data sending apparatus of claim 16, wherein the data connection service identifier inserting means uses a code for the data connection service identifier which is not used in a KS5601 standard.

19. The data sending apparatus of claim 17 or 18, wherein the code is 98H or 99H.

20. The data sending apparatus of claim 16, further comprising reference number field inserting means for inserting a reference number field, which indicates a number for referring to a type of data connection service employed, into a position next to the data connection service identifier in the user data field.

21. The data sending apparatus of claim 16, further comprising short message field translating means for translating a delivery message and extracting an identifier requesting retransmission of data.

22. The data sending apparatus of claim 21, wherein the short message field translating means comprises means for extracting a field indicating a total number of short messages and a field indicating a retransmission request short message number.

23. The data sending apparatus of claim 21, wherein the short message processing means receives a field indicating a total of segmented short messages and a field indicating a retransmission request short message number from the short message field translating means, and inserts a data field corresponding to the retransmission request short message number into a separate user data field; and the short message field generating means generates a retransmission short message field using the separate user data field.

24. A data receiving apparatus using short message service, the apparatus comprising:
service identifying means for checking a user data field of a delivery short message to extract a data connection service identifier, outputting a control signal having a first logic level when the data connection service identifier satisfies a predetermined condition, and outputting said control signal having a second logic level when the data connection service identifier does not satisfy said predetermined condition;
short message field translating means for translating data in a short message area among the user data field of the delivery message, in response to the control signal having the first logic level;
short message storage/connection means for storing and connecting said translated data; and
ordinary short message processing means for performing an ordinary short message process in response to the control signal having the second logic level.

25. The data receiving apparatus of claim 24, wherein the short message field translating means comprises means for extracting a field indicating a total number of short messages and a field indicating a current short message number, and the short message storage/connection means comprises means for outputting connected data to a higher processing layer after storing and connecting data fields as indicated by the total number of short messages.

26. The data receiving apparatus of claim 24, further comprising:
retransmission request short message number inserting means for outputting a field indicating a short message number of a field, in which extraction of the data fails, and inserting the field indicating the short message number of the field in which extraction of the data fails, into a separate user data field as a retransmission request short message number, if extraction of the data in the short message area fails;
user data field generating means for generating a short message field using the separate user data field; and
transmitting means for transmitting the short message field.

27. The data receiving apparatus of claim 24, wherein the service identifying means extracts a code as the data connection service identifier which is not used in an ASCII code table.

28. The data receiving apparatus of claim 24, wherein the service identifying means extracts a code as the data connection service identifier which is not used in a KS5601standard.

29. The data receiving apparatus of claim 27 or 28, wherein the code is 98H or 99H.
